(19) United States
(12) Patent Application Publication
(10) Pub. No.: US 2022/0161192 A1
(43) Pub. Date: May 26, 2022

(54) METHOD FOR OPERATING A TREATMENT SYSTEM, TREATMENT SYSTEM, AND USE OF A TREATMENT SYSTEM

(71) Applicants: Dürr Systems AG, Bietigheim-Bissingen (DE); Chemetall GmbH, Frankfurt (DE)

(72) Inventors: Jürgen WESCHKE, Weil der Stadt (DE); Oliver SAUER, Unter-Schönmattenwa (DE); Tobias HOFMANN, Grünsfeld (DE)

(21) Appl. No.: 17/441,607

(22) PCT Filed: Mar. 20, 2020
(86) PCT No.: PCT/DE2020/100226

§ 371 Date: Sep. 21, 2021

(30) Foreign Application Priority Data
Mar. 22, 2019 (DE) 10 2019 203 989.8

(51) Int. Cl. B01D 61/02; B01D 69/02; B01D 71/56; B05D 1/18; B05D 3/00; B05D 7/24; C23C 22/06; C23C 22/82

(52) U.S. Cl. CPC B01D 61/027; B01D 69/02; B01D 71/56; B05D 1/18; B05D 3/007; B01D 2311/2649; C23C 22/06; C23C 22/82; B01D 2311/18; B01D 2325/20; B01D 2325/34; B05D 7/24

(57) ABSTRACT

The invention relates to a method for operating a treatment system, by means of which an optimized workpiece treatment is facilitated. The method for operating a treatment system comprises the following steps:
guiding workpieces through a treatment basin filled with a treatment medium in order to treat the workpieces;
rinsing the workpieces with a rinsing medium while and/or after the workpieces are removed from the treatment basin;
and producing the rinsing medium from the treatment medium, wherein the rinsing medium is produced using a preparation device preferably by filtering, in particular nano-filtering, the treatment medium.

### RELATED APPLICATION

This application is a national phase of international application No. PCT/DE2020/100226 filed on Mar. 20, 2020 and claims the benefit of German application No. 10 2019 203 989.8 filed on Mar. 22, 2019, which are incorporated herein by reference in their entirety and for all purposes.

### FIELD OF DISCLOSURE

The present invention relates to a treatment system, to a method for operating a treatment system, and to a use of the treatment system, in particular for treating workpieces.

### BACKGROUND

Treatment systems can be used for coating, for example, in workpiece processing. For example, a treatment system can be a system for zinc phosphating of workpieces, in particular vehicle bodies.

A treatment system for treating workpieces is known, for example, from DE 101 42 933 A1.

### SUMMARY OF THE INVENTION

The present invention is based on the object of providing a method for operating a treatment system, a treatment system, and a use of a treatment system, in which an optimized workpiece treatment is facilitated.

According to the invention, this object is achieved by the features of the independent claims.

The method for operating a treatment system preferably comprises the following:

guiding workpieces through a treatment basin filled with a treatment medium in order to treat the workpieces;

rinsing the workpieces with a rinsing medium while and/or after the workpieces are removed from the treatment basin.

When the treatment system is operated in this way, a large amount of rinsing medium can arise which is not allowed to be introduced into the treatment basin but contains treatment medium and therefore may have to be processed or disposed of in a complex manner. In addition, when the treatment system is operated in this way, a large amount of treatment medium can be consumed if the treatment medium adheres to the workpieces and is carried out of the treatment basin with them.

It can therefore be advantageous if the rinsing medium is produced from the treatment medium.

In one embodiment of the invention, it can be provided that the rinsing medium is produced by filtering, in particular nano-filtering, the treatment medium.

The treatment medium is preferably separated into a permeate and a retentate by filtering, in particular nano-filtering. The permeate can be used, for example, as a rinsing medium, in particular without any after-treatment of the permeate subsequent to the filtering.

Furthermore, it can be provided that the treatment medium is separated into a permeate and a retentate by filtering, in particular nano-filtering and that the permeate is used as a rinsing medium, wherein at least approximately 50%, in particular at least approximately 75%, preferably at least approximately 95%, of the substances required for treating the workpieces are separated from the treatment medium during filtering. The substances required for treating the workpieces, in particular the film-forming components, preferably comprise one or more of the following substances: at least one organoalkoxysilane and/or at least one hydrolysis product and/or condensation product thereof, at least one zirconium compound, titanium compound, and/or hafnium compound, manganese ions, copper ions, and/or fluoride, in particular free fluoride.

An organoalkoxysilane has at least two hydrolyzable alkoxy groups and at least one organic, non-hydrolyzable group per molecule, wherein the alkoxy groups are attached via an Si—O bond and the non-hydrolyzable groups are attached via an Si—C bond.

It can be advantageous if the treatment medium is film-forming and comprises individual or a plurality of the following substances as film-forming components: at least one organoalkoxysilane and/or at least one hydrolysis product and/or condensation product thereof, at least one zirconium compound, titanium compound, and/or hafnium compound, manganese ions, copper ions, and/or fluoride, in particular free fluoride.

It can be particularly advantageous if the treatment medium is film-forming and comprises, as film-forming components, at least one zirconium compound, titanium compound, and/or hafnium compound, in particular at least one zirconium compound, and at least one organoalkoxysilane and/or at least one hydrolysis product and/or condensation product thereof, so that and/or wherein the treatment medium is or forms a zirconium oxide-based thin-film system.

The treatment of the workpieces is, in particular, a coating of the workpieces.

It can be expedient if an epoxy resin and/or phenolic resin for producing and/or forming a coating is produced using the treatment medium.

As an alternative or in addition to this, it can be provided that, using the treatment medium, the workpieces are provided with a film which comprises an epoxy resin and/or phenolic resin or is formed from an epoxy resin and/or phenolic resin.

In particular, a film can be formed which is formed from or comprises an amine-modified epoxy resin (polyepoxide).

If the rinsing medium is to be produced from the treatment medium and the treatment medium comprises, in particular, one or more of the substances described above, it can be advantageous for optimized filtering, in particular nano-filtering, if the treatment medium has a pH value prior to filtering, in particular nano-filtering, which is adapted in particular to a membrane for carrying out the filtering, in particular nano-filtering.

The pH value is in particular at least 4, for example at least 4.5, preferably at least 5. As an alternative or in addition to this, it can be provided that the pH value is at most approximately 6, in particular at most approximately 5.5, preferably at most approximately 5.

It can also be favorable if the rinsing medium has a pH value of at least 3, for example at least 3.5, also for example at least 4, in particular at least 4.5, preferably at least 5, before an application thereof to the workpieces. In this way, in particular, an efficient rinsing effect can be achieved. In addition, a subsequent reaction of the treatment medium adhering to the workpieces can thereby preferably be quickly prevented.

In particular, a membrane is used to produce the rinsing medium from the treatment medium. A flux of a membrane used for filtering, in particular nano-filtering, is preferably at most approximately 50l/m² h, in particular at most approximately 35l/m² h.

A plurality of membranes for filtering, in particular nano-filtering, are preferably provided, which, in particular parallel to one another, allow a passage of the treatment medium through them in order to produce the rinsing medium.

A treatment system for treating workpieces is in particular a treatment system for coating workpieces.

The treatment system preferably comprises the following:

a treatment basin which is filled or can be filled with a treatment medium in order to treat the workpieces;

a rinsing device for applying a rinsing medium to the workpieces;

a preparation device for producing the rinsing medium from the treatment medium, wherein the rinsing medium is producible using the preparation device preferably by filtering, in particular nano-filtering, the treatment medium.

The treatment system preferably has one or more of the features and/or advantages described in connection with the method.

The treatment system preferably comprises two serially arranged pump devices for driving the treatment medium and/or rinsing medium.

An intermediate filter device, in particular a cartridge filter and/or a gravel filter, and/or a glass bead filter and/or a security filter, is preferably arranged between the two pump devices. A pore size of such a filter device is preferably at most approximately 20 μm, for example at most approximately 10 μm, for example at most approximately 1 μm.

At least one pump device is preferably open-loop and/or closed-loop controllable by a control device of the treatment system in such a way that an increasing pressure drop in the intermediate filter device, which results from an increasing load factor of the intermediate filter device with increasing operating time, is compensated. In particular, the at least one pump device can be controlled for this purpose using a frequency converter.

The pressure drop can be determined in particular using a sensor device.

It can be favorable if the preparation device comprises a plurality of membrane modules for filtering, in particular nano-filtering, the treatment medium. The membrane modules, in particular parallel to one another, allow preferably a passage of the treatment medium through them.

At least one pump device is preferably open-loop and/or closed-loop controllable by a control device of the treatment system in such a way that an increasing pressure drop in the one or more membrane modules, which results from an increasing load factor of the one or more membrane modules with increasing operating time, is compensated. In particular, the at least one pump device can be controlled for this purpose using a frequency converter.

It can be advantageous if the preparation device comprises a single pressure pipe stage.

The preparation device preferably comprises a pretreatment device, which is arranged upstream of one or more membrane modules of the preparation device with respect to a flow direction of the treatment medium. The pretreatment device preferably comprises a separation device for separating particulate contents of the treatment medium.

The treatment system according to the invention is particularly suitable for carrying out the method according to the invention.

The present invention therefore also relates to the use of a treatment system, in particular a treatment system according to the invention, for carrying out a method, in particular a method according to the invention.

In particular, a thin film can be applied to a workpiece using the method. Such a thin film is producible, for example, using a zirconium oxide-based thin-film system.

For example, Oxsilan from Chemetall can be provided as the film-forming treatment medium.

When coating workpieces in a thin-film process, it can be disadvantageous if a coating process continues on a workpiece surface after the workpiece has been removed from the treatment medium. An adhering liquid film and/or so-called runs, which emerge from workpiece gaps and/or run over the workpiece surface, for example, can result in excessive coating and/or so-called run markings. This can represent a considerable loss of quality and/or a coating defect, which has to be reworked in a costly manner in subsequent work steps.

It can therefore be provided that the workpieces are rinsed when leaving and/or after leaving the treatment basin, for example when using water, preferably fully desalinated water (demineralized water).

The rinsing medium used to rinse off the workpieces can, for example, be introduced into the treatment basin or be received in some other way.

If the rinsing medium is introduced into the treatment basin, a dilution of the treatment medium or another influence of the composition of the treatment medium arises, for example, in some other way due to the rinsing medium. This can be compensated for, for example, by a continuous exchange of treatment medium in the treatment basin, in particular by disposing of or processing a bath overflow from the treatment basin in order to remove unwanted reaction products from the bath and to avoid the accumulation of non-film-forming components in the bath.

However, as the amount of rinsing medium increases, this can result in a large consumption of treatment medium and/or a great preparation effort. In addition, undesirable substances can accumulate in the treatment medium, for example non-film-forming components, in particular nitrate, which can only be removed from the treatment medium with great effort.

If the rinsing medium is now produced from the treatment medium, there are numerous advantages. In particular, an amount of the rinsing medium can be independent of an amount of treatment medium discharged, fed out, and/or disposed of from the treatment basin.

The amount of rinsing medium for rinsing the workpieces can thus be increased significantly without diluting or otherwise impairing the treatment medium.

In addition, the treatment medium discharged from the treatment basin by the workpieces does not have to be processed or disposed of separately.

In particular, less wastewater thus needs to be discharged from processes for workpiece treatment and correspondingly less fresh water needs to be supplied, whereby resource-saving and cost-efficient operation is facilitated.

A permeate is preferably generated from the treatment medium with the aid of nano-filtering, by means of which the workpieces are rinsed off. The retentate, in particular a concentrate of the treatment medium, is preferably fed back into the treatment basin.

The retentate contains in particular the film-forming components of the treatment medium. In this way, a concentration of the film-forming components in the treatment medium can preferably be kept at least approximately constant.

Depending on the number and size of the workpieces, an amount of 1 to 3 l/m² of workpiece surface can in particular be provided as the amount of rinsing medium.

A membrane of a membrane module is in particular a thin-film composite membrane which, for example, has an active separating layer made of polyamide and/or a MWCO (molecular weight cut-off) in the range of at least approximately 100 Da, for example at least approximately 150 Da, preferably at most approximately 400 Da, for example at most approximately 300 Da.

Surprisingly, in the case of a zirconium oxide-based thin-film system for producing the rinsing medium, thin-film composite membranes are suitable, in particular those which preferably have an active separating layer made of polyamide and/or a MWCO of at least 100 Da.

A nanofiltration membrane can be, for example, NF270 from Dow Chemical and/or Desal HL from Suez. In particular, these membranes are preferably characterized by a retention of an MgSO₄ solution of at least approximately 90%, for example at least approximately 95% or at least approximately 97%.

A separation of the film-forming components of the treatment medium is preferably achieved using the nano-filtering without a complete desalination of the treatment medium.

The film-forming components of the treatment medium, in particular at least one organoalkoxysilane and/or at least one hydrolysis product and/or condensation product thereof, at least one zirconium compound, titanium compound, and/or hafnium compound, manganese ions, copper ions, and/or fluoride, in particular free fluoride, are preferably retained by at least approximately 50%, preferably at least approximately 70%, in particular at least approximately 90%, and/or at most approximately 99%, in particular at most approximately 98%, in particular to avoid post-reaction on the workpiece.

Excessive desalination of the treatment medium can result in severe acidification of the permeate and thus of the rinsing medium. This can in particular result in a pH value-related dissolution of a coating on the workpiece and/or to the formation of a rust film, in particular on steel surfaces, which of course should be avoided.

The membrane is designed in particular to avoid an excessive pH value shift in the acidic range and also to ensure adequate retention of the film-forming components.

In particular if the treatment medium, in addition to inorganic components such as at least one zirconium compound, titanium compound, and/or hafnium compound, manganese ions, copper ions, and/or fluoride, in particular free fluoride, also comprises organic components such as at least one organoalkoxysilane and/or at least one hydrolysis product and/or condensation product thereof, so-called organic fouling can occur. This can occur in particular with an increased flux or permeate volume flow.

If the flux or permeate volume flow is below specific limit values, for example below 50 l/m² h, in particular at most approximately 35l/m² h, flux waste associated with organic fouling is preferably so low that a chemical cleaning cycle to clean the membrane is several weeks or even several months. Thereby, an efficient, low-maintenance operation is facilitated.

The fouling potential of a fluid volume flow (treatment medium flow) supplied to the membrane can preferably be reduced by the pretreatment device. The fouling potential is expressed in particular as a colloid index (CI) or as a silt density index (SDI), wherein a value of less than 8, for example less than 5, in particular less than 3, is preferably achieved.

If chemical cleaning is required, a weakly alkaline or weakly acidic rinse can in particular be provided in order to remove residual deposits from the membrane.

Before the treatment medium is fed to a membrane, the treatment medium is preferably pretreated, in particular for the separation of particulate contents. In particular, bath maintenance devices that are preferably provided, for example for removing pickling and/or precipitation sludge from the treatment medium, can thereby be used.

A pretreatment device can for example comprise a chamber filter press, a gravel filter, and/or a glass bead filter. The capacity of the pretreatment device is adapted in particular to the capacity of the one or more membrane modules, in particular in order to ensure constant volume flow at the one or more membrane modules.

For example, when retrofitting an existing treatment system in which, for example, a bag filter with reduced particle retention is provided, this can be replaced, for example, by a fully automatic gravel or glass bead filter. In particular, two tanks are provided in each case, wherein one is operated in a filter mode and one in a backwash mode or standby mode.

The treatment medium is preferably not saturated in a state intended for treating workpieces, in particular with regard to possible precipitations.

The treatment medium can preferably be concentrated up to a concentration factor of at least 3, in particular at least 4, without precipitations occurring. One part of concentrate/retentate then results in particular from at least three or at least four parts of treatment medium. Correspondingly, at least two parts or at least three parts of permeate are provided as the rinsing medium.

A water recovery (wrc) is thus, for example, at least approximately 60%, for example at least approximately 75%.

Further preferred features and/or advantages of the invention are the subject matter of the following description and the graphic illustration of embodiments.

### BRIEF DESCRIPTION OF THE DRAWINGS

FIG. 1 is a schematic illustration of a treatment system in which a conventional rinsing device is provided; and

FIG. 2 is a schematic illustration of a treatment system corresponding to FIG. 1, in which a preparation device is provided for producing a rinsing medium from treatment medium.

Identical or functionally equivalent elements are provided with the same reference signs in all figures.

### DETAILED DESCRIPTION OF THE DRAWINGS

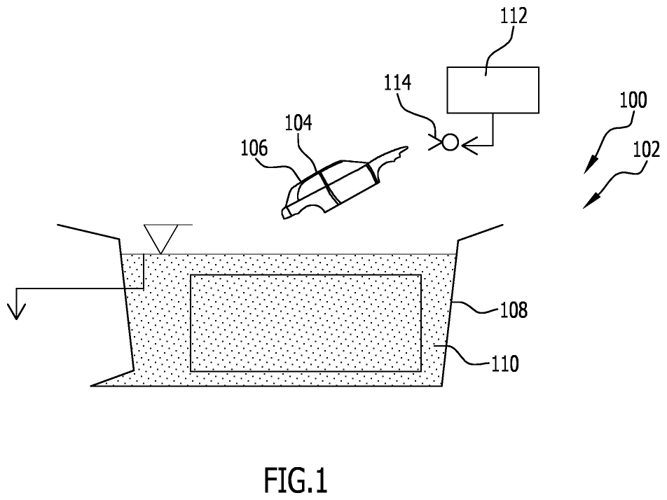

A first embodiment, shown in FIG. 1, of a treatment system designated as a whole by 100 is, for example, an immersion treatment system 102 for treating workpieces 104.

The workpieces 104 are vehicle bodies 106, for example.

In particular, a protective layer, for example a corrosion protective layer, or some other coating can be applied to the workpiece 104 using the treatment system 100.

For this purpose, the treatment system 100 comprises a treatment basin 108 which is filled with a treatment medium 110 and into which the workpiece 104 can be immersed.

The treatment medium 110 is in particular a thin-film system for coating workpieces 104.

The thin-film system is in particular a zirconium oxide-based thin-film system.

If the workpieces 104 are now removed from the treatment basin 108, the use of such a thin-film system can in particular result in a more extensive coating of the workpiece 104 in the regions in which the treatment medium 110 still adheres to the workpiece 104, for example in the form of drops or runouts on a surface of the workpiece 104.

This can result in an impairment of the coating quality.

The treatment system 100 therefore preferably comprises a rinsing device 112, by means of which a rinsing medium 114 can be applied to the workpiece 104.

The rinsing medium 114 allows in particular an immediate removal of the treatment medium 110 from the workpiece 104 in order to stop a coating process immediately after the removal of the workpiece 104 from the treatment basin 108.

As a result, a mixture of rinsing medium 114 and treatment medium 110 is produced, which, depending on the composition of the treatment medium 110 and/or of the rinsing medium 114, may have to be disposed of or processed in a complex manner.

If the rinsing medium 114 together with the treatment medium 110 rinsed off from the workpiece 104 is simply introduced into the treatment basin 108, a dilution of the treatment medium 110 or some other chemically different composition of the treatment medium 110 can result, which can impair the treatment process.

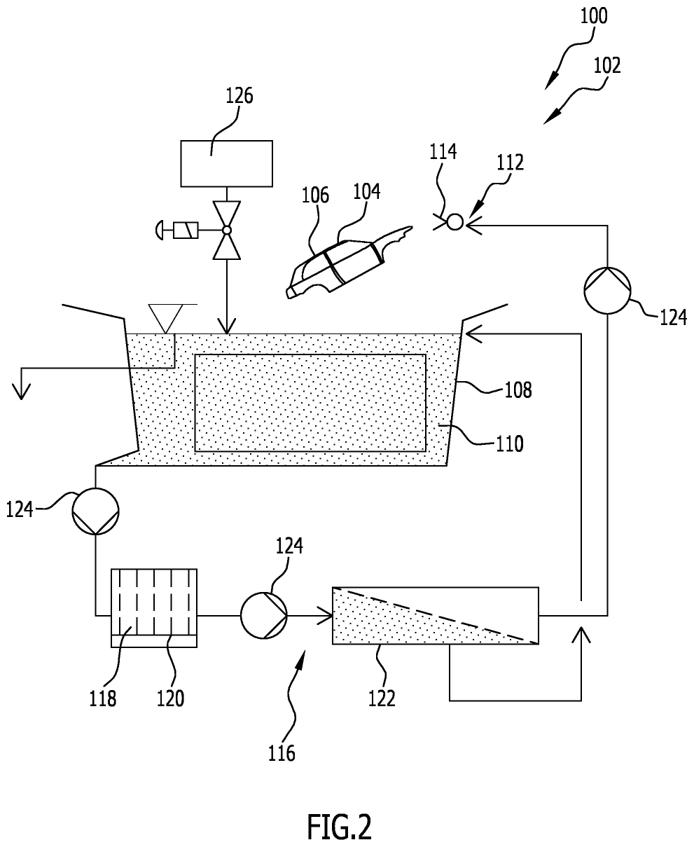

A second embodiment of a treatment system 100 shown in FIG. 2 therefore preferably comprises a preparation device 116, by means of which rinsing medium 114 can be produced from the treatment medium 110.

In particular, the treatment medium 110 can be materially separated using the preparation device 116, in order in particular to separate off the film-forming components of the treatment medium 110. The treatment medium 110 which is at least approximately completely freed from the coating components can then be used as a rinsing medium 114.

Both parts separated from one another using the preparation device 116 can be brought together in the treatment basin 108, which results in a substantially constant composition of the treatment medium 110 in the treatment basin 108.

The preparation device 116 preferably comprises a pretreatment device 118 and/or an intermediate filter device 120.

Using the pretreatment device 118 and/or the intermediate filter device 120, it is possible, in particular, to separate particulate components, for example suspended matter, etc. from the treatment medium 110.

One or more membrane modules 122 of the preparation device 116, which separate a portion of the liquid that can be used as a rinsing medium 114 from the treatment medium 110, are preferably protected from coarse contamination using the pretreatment device 118 and/or the intermediate filter device 120.

The preparation device 116 preferably comprises a plurality of pump devices 124.

In particular, a pump device 124 is arranged upstream of the pretreatment device 118 and/or the intermediate filter device 120.

A further pump device 124 can be arranged downstream of the pretreatment device 118 and/or the intermediate filter device 120 and/or upstream of the one or more membrane modules 122.

Finally, a pump device 124 can be provided downstream of the one or more membrane modules 122, for example.

The pump devices 124 can in particular be open-loop and/or closed-loop controllable as a function of a differential pressure upstream or downstream of the one or more membrane modules 122.

In particular, a pressure difference that varies in the one or more membrane modules 122 due to varying impurities can be compensated by the pump device 124. In this way, a predetermined amount of rinsing medium can be reliably provided.

In the embodiment of the treatment system 100 shown in FIG. 2, a continuous, low-maintenance and efficient treatment operation preferably results.

In particular, only a small amount of additional treatment medium 110, liquid, for example fully desalinated water, and/or coating components of the treatment medium 110 is required, for example using a feed device 126, in order to maintain a continuous treatment operation.

It can be advantageous to maintain a predetermined pH value range of the treatment medium 110 and/or of the rinsing medium 114 so that the preparation device 116 reliably provides a medium that can be used as a rinsing medium 114. In particular, a nanofiltration membrane can be provided as the membrane in one or more membrane modules 122, which allows a pH value of the rinsing medium 114 of at least 4, for example at least 4.5, if the pH value of the treatment medium 110 is, for example, between approximately 4 and 5, and a retention of the film-forming components of the treatment medium 110 is at least approximately 60%, for example at least approximately 90%, in particular approximately 98%.

By maintaining the stated pH value range, it is possible in particular to prevent the rinsing medium 114 from loosening or otherwise damaging the coating adhering to the workpiece 104.

The preparation device 116 is preferably dimensioned and designed in such a way that a single pressure pipe stage is provided. In this way, the effort for chemical rinsing can preferably be reduced. In particular, a fully automatic mode of operation of the preparation device 116 is possible.

Incidentally, the second embodiment of the treatment system 100 shown in FIG. 2 corresponds in terms of structure and function to the embodiment shown in FIG. 1 so that reference is made to the above description. In further embodiments (not shown), any combination of features of the embodiments described above can be provided, optionally in combination with individual or multiple features of the introduction to the description.

1. Method for operating a treatment system, comprising:
guiding workpieces through a treatment basin filled with a treatment medium in order to treat the workpieces;
rinsing the workpieces with a rinsing medium while and/or after the workpieces are removed from the treatment basin,
wherein the rinsing medium is produced from the treatment medium.

2. Method according to claim 1, wherein the rinsing medium is produced by filtering, in particular nano-filtering, the treatment medium.

3. Method according to claim 2, wherein the treatment medium is separated into a permeate and a retentate by filtering, in particular nano-filtering, and wherein the permeate is used as a rinsing medium, in particular without any after-treatment of the permeate subsequent to the filtering.

4. Method according to claim 2, wherein the treatment medium is separated into a permeate and a retentate by filtering, in particular nano-filtering, and wherein the permeate is used as a rinsing medium, wherein at least approximately 50%, in particular at least approximately 75%, preferably at least approximately 95%, of the substances required for treating the workpieces are separated from the treatment medium during filtering, wherein the substances required for treating the workpieces preferably comprise one or more of the following substances: at least one organoalkoxysilane and/or at least one hydrolysis product and/or condensation product thereof, at least one zirconium compound, titanium compound, and/or hafnium compound, manganese ions, copper ions, and/or fluoride, in particular free fluoride.

5. Method according to claim 1, wherein the treatment medium is film-forming and comprises, as film-forming components, at least one zirconium compound, titanium compound, and/or hafnium compound, in particular at least one zirconium compound, and at least one organoalkoxysilane and/or at least one hydrolysis product and/or condensation product thereof, so that and/or wherein the treatment medium is or forms a zirconium oxide-based thin-film system.

6. Method according to claim 1, wherein an epoxy resin and/or phenolic resin for producing and/or forming a coating is produced using the treatment medium and/or
wherein, using the treatment medium, the workpieces are provided with a film which comprises an epoxy resin and/or phenolic resin or is formed from an epoxy resin and/or phenolic resin.

7. Method according to claim 1, wherein the treatment medium has a pH value of at least approximately 4, in particular at least approximately 4.5, preferably at least approximately 5, prior to filtering, in particular nano-filtering, the same.

8. Method according to claim 1, wherein the treatment medium has a pH value of at most approximately 6, in particular at most approximately 5.5, preferably at most approximately 5, prior to filtering, in particular nano-filtering, the same.

9. Method according to claim 1, wherein the rinsing medium has a pH value of at least 4, in particular at least 4.5, preferably at least 5, prior to the application thereof onto the workpieces.

10. Method according to claim 1, wherein a flux of a membrane used for filtering, in particular nano-filtering, is at most approximately 50 l/m² h, in particular at most approximately 35 l/m² h.

11. Treatment system for treating workpieces, wherein the treatment system comprises:
a treatment basin which is filled or can be filled with a treatment medium in order to treat the workpieces;
a rinsing device for applying a rinsing medium to the workpieces;
a preparation device for producing the rinsing medium from the treatment medium, wherein the rinsing medium is producible using the preparation device preferably by filtering, in particular nano-filtering, the treatment medium.

12. Treatment system according to claim 11, wherein the treatment system comprises two serially arranged pump devices for driving the treatment medium and/or the rinsing medium, wherein an intermediate filter device, in particular a cartridge filter device, is arranged between the two pump devices, and wherein at least one pump device is open-loop and/or closed-loop controllable by a control device in such a way that an increasing pressure drop in the intermediate filter device, which results from an increasing load factor of the intermediate filter device with increasing operating time, is compensated.

13. Treatment system according to either claim 11, wherein the preparation device comprises one or more membrane modules for filtering, in particular nano-filtering, the treatment medium, wherein the membrane modules, in particular parallel to one another, allow a passage of the treatment medium through them.

14. Treatment system according to claim 11, wherein the preparation device comprises one or more membrane modules for filtering, in particular nano-filtering, the treatment medium, wherein the membrane modules each comprise one or more thin-film composite membranes which preferably have an active separating layer made of polyamide and/or a MWCO (molecular weight cut-off) of at least 100 Da.

15. Treatment system according to claim 11, wherein the preparation device comprises a single pressure pipe stage.

16. Treatment system according to claim 11, wherein the preparation device comprises a pretreatment device which is arranged upstream of one or more membrane modules of the preparation device with respect to a flow direction of the treatment medium, wherein the pretreatment device comprises a separation device for separating particulate contents of the treatment medium.

17. Use of a treatment system according to claim 11 for carrying out a method according to claim 1.
